(19) United States
(12) Patent Application Publication
(10) Pub. No.: US 2005/0277085 A1
(43) Pub. Date: Dec. 15, 2005

(54) Viewing instrument

(76) Inventor: Stuart Coleton, Chappaqua, NY (US)

Correspondence Address: LADAS & PARRY, 26 WEST 61ST STREET, NEW YORK, NY, 10023, US

(21) Appl. No.: 11/149,695

(22) Filed: Jun. 10, 2005

Related U.S. Application Data
(60) Provisional application No. 60/579,493, filed on Jun. 14, 2004.

(51) Int. Cl. A61C 1/00

(52) U.S. Cl. 433/31

(57) ABSTRACT

A viewing instrument, particularly for use in dentistry, in which a finger or like element is attachable to or integral with a mirror to hold material out of the sight-line when viewing the mirror. In the case of a dental implement, the element is a retractor attached or attachable to a dentists inspection mirror.

### FIELD OF THE INVENTION

The invention finds particular use in the field of dentistry and will primarily be described in terms of a dental instrument.

### BACKGROUND OF THE INVENTION

Dentists, dental surgeons, and periodontists traditionally use small viewing mirrors during oral inspections and procedures. Such viewing mirrors can be used on their own during routine dental procedures such as, for example, drilling. However, for a thorough investigation it is usually necessary to observe a portion of a tooth or bone which lies below the gum line and, in order to do this, the gum and/or surrounding tissue must be moved aside to expose the area for inspection. To move gum or tissue aside, a variety of dental instruments may be used, but, most commonly, the instrument used is a dental elevator. An elevator is an elongated instrument having a “pusher” at one end. It is a relatively simple matter for the dentist to hold the mirror in one hand and to orient the reflecting mirror surface to enable him to see the area to be examined. The dentist then takes the elevator in the other hand and applies the “pusher” element to the gum or tissue and pushes or displaces the gum or tissue aside to enable the exposed area which had until then been covered by the gum or tissue to be viewed in the mirror. For continued viewing of the area, it is no longer necessary to utilize the elevator which, by virtue of the purpose it has to perform, is a relatively robust instrument, and it is sufficient for the dentist to exchange the elevator for a retractor which is a more delicate instrument and it used merely to hold the displaced gum or tissue out of the way or at least in a position in which viewing of the area under consideration is not impeded. At this point the dentist has both his hands occupied, one holding the mirror and the other holding a retractor, and may wish to make a more thorough investigation using a manual probe or other appropriate dental instrument. He is faced then with the decision to replace either the mirror or the retractor in order to free up the hand to manipulate the probe or the dental instrument. If neither the mirror nor the retractor can be dispensed with, then it would be necessary for a nurse or dental assistant to take over the retractor or the mirror while the dentist then uses his freed up hand for a more physical inspection of the tooth or surrounding area. Quite apart from the inconvenience of having a third party hold a mirror at the precise angle at which the dentist obtains the best view of the area under inspection, the space for two people (three hands) is extremely restricted around the limited area of the mouth of a patient.

The invention makes it possible for a single practitioner, the dentist, to use only one hand both to hold the gum or tissue out of the way and to observe the area either under inspection or being treated.

According to the present invention there is provided a dental implement having an elongated handle, a mirror at one end of said handle, and a retractor integral with or adjustably affixed to said mirror.

According to a further aspect of the present invention, there is provided a viewing instrument comprising an elongated handle, a mirror at one end of said handle and a finger or like element projecting beyond and fixed or removably attached to said mirror.

### INTRODUCTION TO THE DRAWINGS

The invention will now be more clearly described with reference to the accompanying drawings in which:

FIGS. 1A and 1B and respectively top and side elevations of a conventional dental implement.

FIGS. 2A and 2B are respectively top and side elevations a conventional dental viewing mirror.

FIG. 3 is top view of a dental implement in accordance with the invention.

FIG. 4 is a side elevation of the implement shown in FIG. 3.

FIG. 5 is bottom view of the implement shown in FIG. 3.

FIG. 6 is a partial side elevation of an alternative embodiment of the instrument shown in FIG. 4.

FIGS. 7 and 8 are respectively top and bottom views taken along lines 7-7 and 8-8 of FIG. 6.

FIG. 9 is a view similar to FIG. 6 but shows a further embodiment of the invention.

FIG. 10 is a bottom view taken along the line 10-10 of FIG. 9.

FIG. 11 is a side elevation of a portion of a further embodiment of the invention.

FIG. 12 is an elevational view taken along the lines of 12-12 of FIG. 11.

FIG. 13 is an elevational view taken along the lines of 13-13 of FIG. 11.

FIG. 14 corresponds to FIG. 13 but is an exploded view of the embodiment.

FIG. 15 is an exploded view similar to FIG. 14 but shows the component parts in a different orientation.

FIG. 16 is a side elevation of an end view of further embodiment of the invention.

FIG. 17 is an elevational view along the line 17-17 of FIG. 16.

FIG. 18 is an elevational view along the line 18-18 of FIG. 16.

FIG. 19 is a sectioned view taken along the line 19-19 of FIG. 14.

FIG. 20 is an inverted sectional view taken along the line 20-20 of FIG. 14.

FIG. 21 is a perspective view of a component of the embodiment shown in FIGS. 11 and 16;

FIG. 22 is a view similar to FIG. 21 but shows a modification of the embodiments shown in FIGS. 11 and 16;

FIG. 23 is a schematic perspective view showing the dental instrument in operation;

FIG. 24 is a perspective view similar to the views of FIGS. 21 and 22 but shows a further embodiment of the invention;

FIG. 25 is a perspective view of the embodiment shown in FIG. 24 but is seen from above;

FIG. 26 is a side elevation of the embodiment shown in FIGS. 24 and 25 taken as seen in the direction 26-26 of FIG. 24;

FIG. 27 is a section along the line of 27-27 of FIG. 24; and

FIG. 28 is a section along the line 28-28 of FIG. 24.

FIG. 29 is a perspective view from below similar to FIG. 24 but showing a further embodiment of the invention; and

FIG. 30 is a perspective view from below similar to FIG. 24 but showing a still further embodiment of the invention

### DESCRIPTION OF PREFERRED EMBODIMENTS

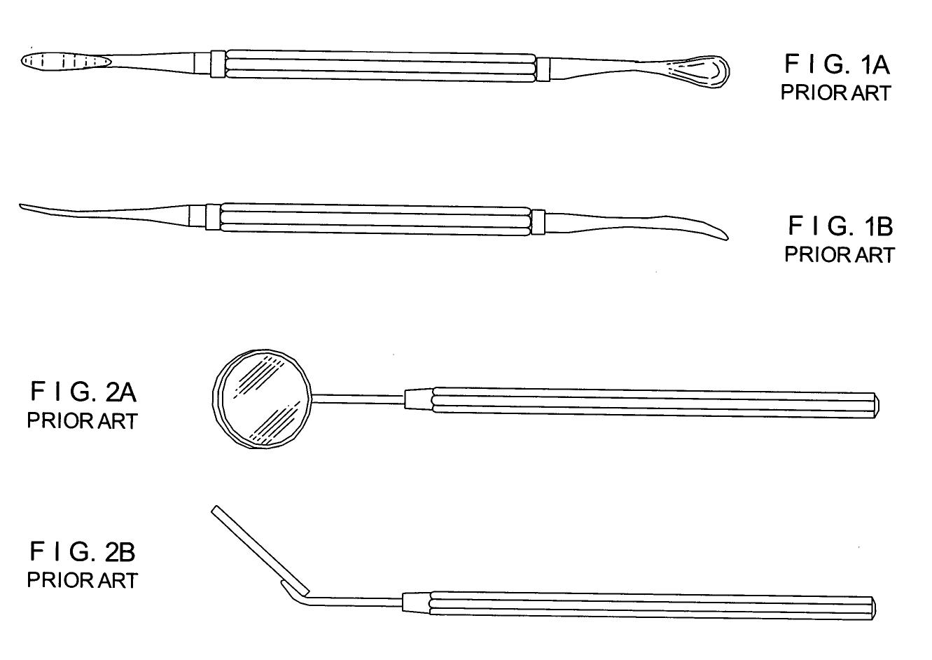

Referring now to the drawings, FIGS. 1A and 1B show a multipurpose dental instrument in which an elevator 1 and retractor 2 are respectively located at opposite ends of an elongated central handle 3. The implement is a one-piece casting and is discarded if either the elevator 1 or retractor 2 become worn or damaged. In the embodiment shown in FIGS. 1A and 1B, the handle 3 is octagonal in cross section to provide longitudinal flats which facilitate in gripping of the implement. Alternatively, the handle 3 could be knurled, dimpled, or otherwise contoured to facilitate gripping.

FIGS. 2A and 2B show a conventional dental mirror having a handle 8 and mirror element 9 at one end thereof. The mirror element 9 is formed by a circular dished receptacle 10 in which a mirror 11 is seated. Although the mirror element can be adhesively secured in the dished receptacle 10, it is preferred that the extremity of the rim of the upstanding walls of the dished receptacle be peened over 12 to retain the seated mirror 11 in position. The dished receptacle 10 is welded or otherwise secured to a stem 13 having an end remote from the mirror element seated axially in the end of the handle 8.

As most clearly shown in FIG. 2B of the drawings, the end of the stem 13 which is secured to the mirror element is preferably angled at 14 in order that the mirror element will be oriented in the manner most conducive to viewing. Again, the gripping surface of the handle 8 is profiled/contoured in a manner to facilitate gripping thereof.

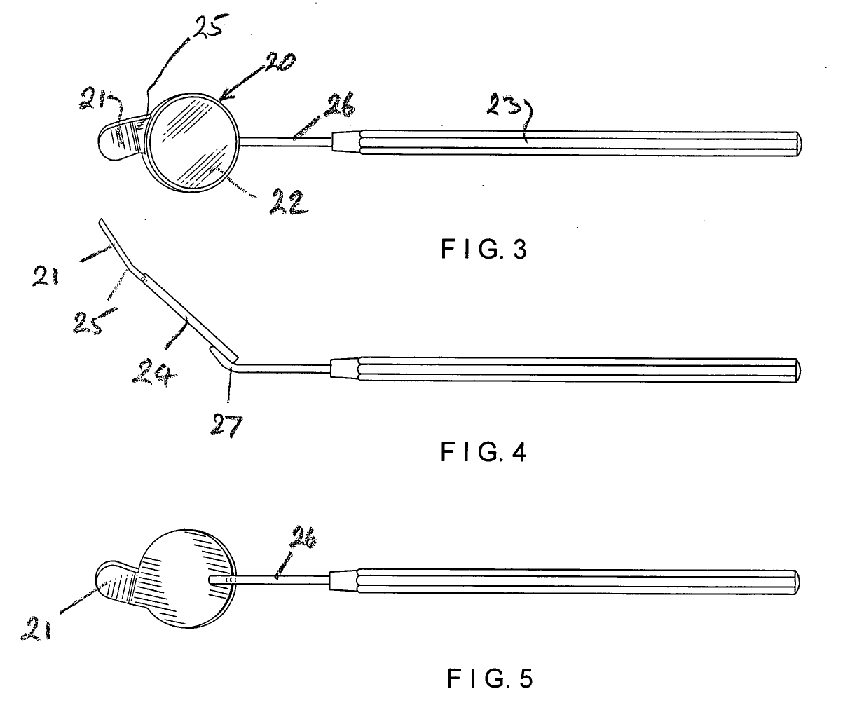

FIG. 3 is a top view of a first embodiment of the invention and shows a mirror element 20 with an integral retractor 21. As best shown in FIG. 23 of the drawings, once the gum 27 of a patient has been displaced by an elevator to expose a region to be examined, the gum can be held in the displaced position by the retractor 21 while the mirror 22 of the mirror element 20 can be manipulated by positioning of a handle 23 to reflect the exposed region of the patient's mouth. Thus, the dentist, dental surgeon, or periodontist can manipulate the implement with one hand, leaving the other hand free to use a probe or other dental instrument closely to examine the exposed region.

Returning to FIGS. 3, 4, and 5, the mirror element comprises a one-piece molding having a dished receptacle 24 in which the mirror element 22 is seated and retained by adhesive, peening over of the circumferential free edge of the receptacle, or by an interference press fit. The retractor 21 and dished receptacle 24 are shown as a one-piece casting with the retractor 21 offset and extending outwardly from the dished receptacle. In modifications, the retractor 21 could extend radially outwardly with respect to the dished receptacle or tangentially therefrom, depending the specific area of the mouth to be examined.

The retractor 21 is angled about a fold line 25 and the dished receptacle 24 is attached at a point spaced from the retractor to one end of stem 26, the other end of which is secured to the handle 23 in an appropriate manner such as, for example, by one of the means described with reference to FIGS. 2A and 2B. The stem 26 is shown as being angled at 27 in order that the mirror element and integral retractor will be oriented at an appropriate position for viewing the exposed region.

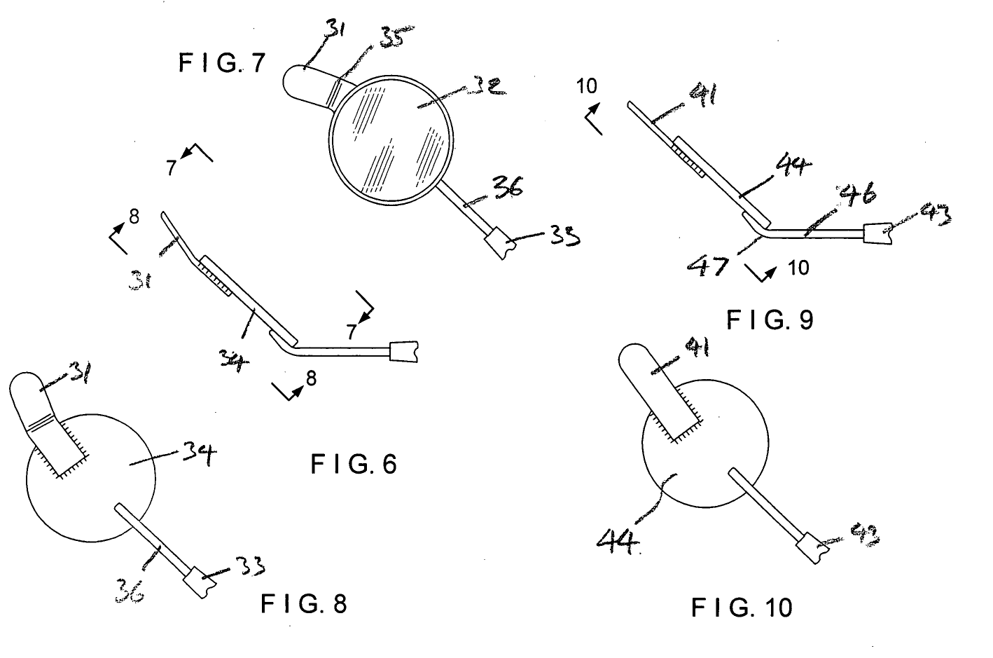

The embodiment shown in FIGS. 6, 7 and 8 is similar to the embodiment of FIGS. 3, 4, and 5, but the retractor 31 is shown welded to the underside of the dished receptacle 34. Again, the retractor 31 is angled about a fold line 35 in order that the gum-contacting region of the retractor 31 lies in the desired plane with respect to the remainder of the implement. As in the embodiment of FIGS. 3, 4, and 5, a mirror 32 is retained in the dished receptacle which is connected by a stem 36 to the end of a handle 33.

FIGS. 9 and 10 show an embodiment very similar to the embodiment of FIGS. 6, 7 and 8, but in the embodiment of FIGS. 9 and 10 the retractor 41 is a flat element which is not angled. In the embodiment of FIGS. 9 and 10, the angling of the retractor 41 with respect to the handle 43 is accomplished by the stem 46 which is angled at 47 with one stem end secured to the handle and the other stem end secured to the dished receptacle 44.

In both the embodiments of FIGS. 6 to 8 and FIGS. 9 to 10, the retractor 31,41 is welded to the underside of the dished receptacle 34, 44. However, securing could be means other than welding such as, for example, by a strong adhesive. However, as the implement is, in use, in the sensitive or vulnerable mouth of a patient, sterilization is important. It is therefore preferred that the entire element be of stainless steel or some other non-reactive metal.

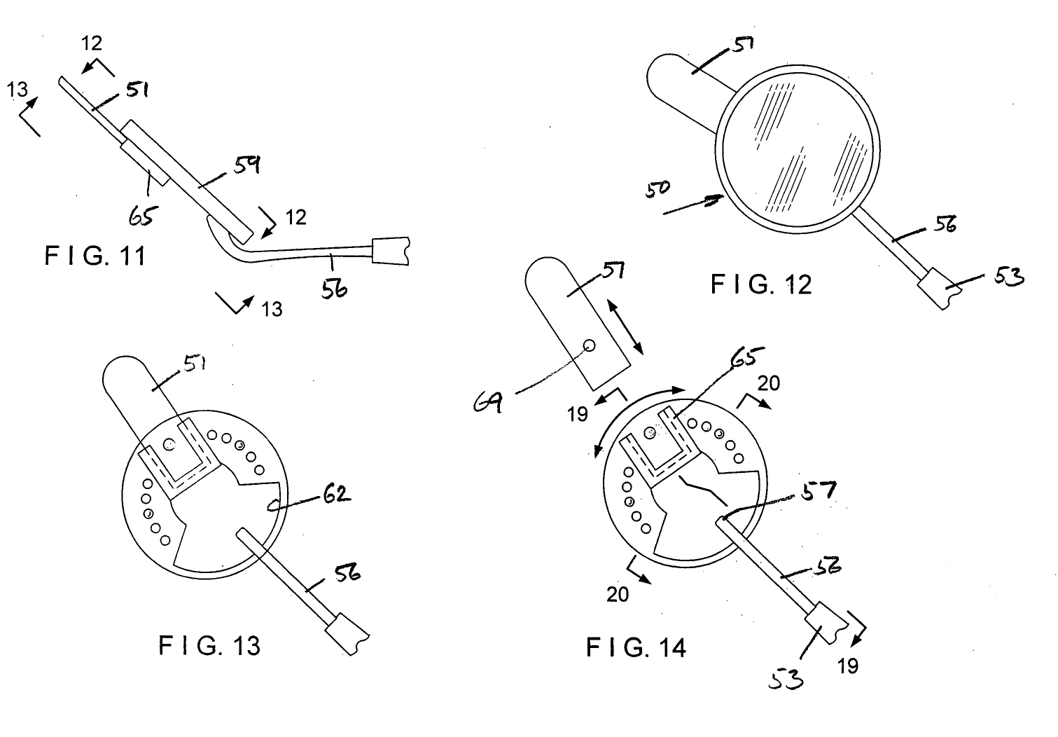

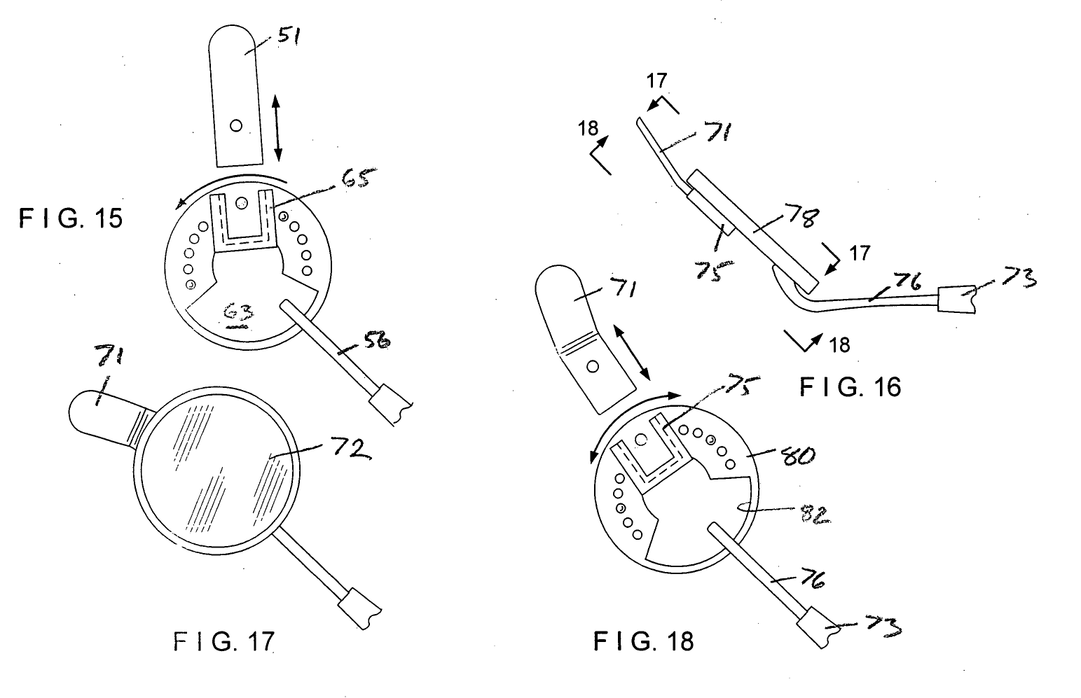

The foregoing paragraphs describe how the retractor extending from the mirror element can be disposed with respect thereto at a number of orientations depending, in part, on the area of the mouth to be examined or the density or amount of gum or tissue to be held out of the way. Unless the retractor is adjustably mounted, this would mean that there would have to be separate implements one for each position of the retractor with respect to the mirror element. To overcome this problem, the embodiments of FIGS. 11 to 15, FIGS. 16 to 18, and FIG. 22 each disclose a retractor which is both adjustable with respect to the axial orientation of the implement and replaceable.

Dealing firstly with the embodiment shown in FIGS. 11 to 15 and FIGS. 19 to 21 of the drawings, element 50 includes a mirror 52 retained within a dished receptacle 54 by adhesive or peening over the annular rim of the receptacle in the manner described with respect to previous embodiments. That dished receptacle 54 is, in turn, disposed within a larger dished receptacle 58. That larger dished receptacle 58 is circular in overall configuration and has a rim upstanding from a flat base 60. The dished receptacle 54 which accommodates the mirror 52 nests within the larger receptacle 58 and is retained therein by peening over 61 the circular uppermost extremity of the rim 59.

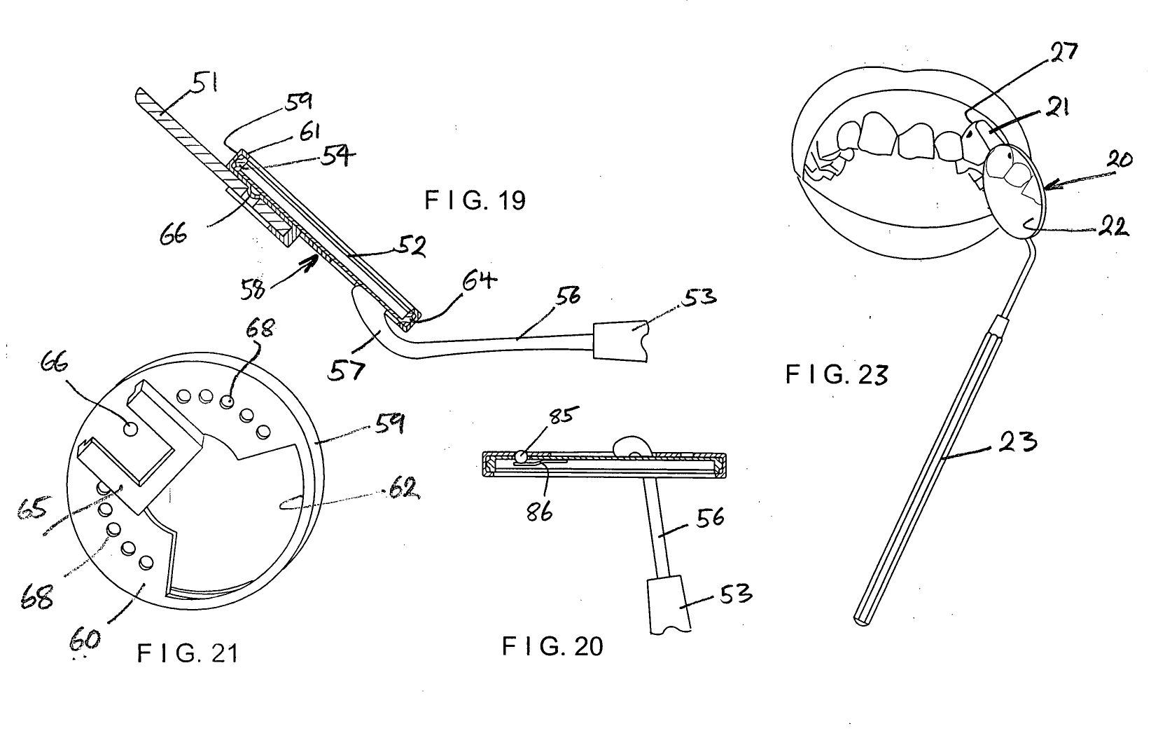

The base 60 has an opening 62, shown in FIG. 21 as a general sector, which provides access to the underside 63 of the nested dished receptacle 54. A stem 56 connects the mirror element 50 to one end of a handle 53. The end 57 of the stem 56 remote from the handle 53 extends through the opening 62 in the base 60 of the larger dished receptacle 58 and is welded or otherwise permanently secured to the underside 63 of the dished receptacle 54. In this manner the larger dished receptacle 58 is free to rotate on and around the nested dished receptacle 54 and, with the nested dished receptacle 54 secured with respect of the handle 53, the larger dished receptacle 58 is moveable with respect to said handle 53. To facilitate such relative rotation between dished receptacles, FIG. 19 shows a peripheral bearing 64 extending around external wall of the rim of the inner nested dished receptacle 54. That bearing bears on the inner wall of the rim 59 of the larger dished receptacle 58 and facilitates rotation, one upon the other.

The releasable attachment of the retractor 51 to the mirror element 50 is best shown in FIGS. 14, 19, and 21. In this embodiment the retractor 51 is plane and has an inner end attachable to the larger dished receptacle 58 and an outer end exposed for contacting gum, tissue or other matter to be restrained by said retractor. The inner end of the retractor 51 is dimensioned to seat within a U-shaped keyway 65 which is shown in FIG. 19 as being integrally cast with the larger dished receptacle but, as explained in previous embodiments, could be a separate component welded or otherwise permanently secured to the underside of the base 60 of the larger dished receptacle 58. FIG. 21 shows how the limbs of the keyway 65 are L-shaped to define an internal channel into which the inner end of the retractor 51 can be introduced and retained.

FIG. 19 of the drawings shows a detent 66 on the underside of the base 60 between the limbs of the U-shaped keyway and dimensioned to engage in an aperture 69 in the retractor 57 releasably to retain said retractor.

The base 60 of the larger dished receptacle 58 has a plurality of apertures 68 disposed in an arc, all at the same radial distance from the mutual axes of the receptacles 54 and 58, and at least one spring-loaded catch is carried by the inner dished receptacle 24 selectively to engage in one of said apertures 68.

As most clearly shown in FIGS. 14 and 20 of the drawings, two such spring-loaded catches may be provided. Each catch includes a ball 85 seated in an aperture in the base of the inner dished receptacle 24 and a leaf spring 86 having one end secured on the inner surface of said base and the other end bearing on the ball 85 to impart spring loading thereto. The leaf springs may be secured on the base diametrically opposed to each other and the section line 20-20 in FIG. 14 is selected to pass through one but not the other of said leaf springs.

It will be appreciated that the or each ball 85 is urged through its accommodating aperture in the base of the inner dished receptacle and as the dished receptacles are rotated with respect to each other will snap into an underlying aperture 68 in the outer receptacle resiliently to lock the receptacles in position. The dimension of each aperture 68 is such that the ball will penetrate sufficiently to effect the desired locking. Alternatively, the apertures could be depressions in the base 60. The force applied by the leaf spring or springs is such that it may be overcome in order further relatively to rotate the receptacles with respect to each other until a ball snaps into a next adjacent aperture to lock said receptacles in a different relationship.

With the retractor 51 held by the outer dished receptacle and the stem 56, and hence the handle 53, secured to the inner dished receptacles, it thus become possible for the angular orientation of the retractor with respect to the handle to be selectively varied.

The embodiment shown in FIGS. 16, 17, and 18 differs from the embodiment described with respect to FIGS. 11 to 15 and FIGS. 19 to 21 only in that the retractor 71 is angled about a fold line most clearly shown in FIG. 16 and 18 and is not planar as in the embodiment of FIGS. 11 to 15. As with the embodiment in FIGS. 11 to 15, the retractor 71 is accommodated in a keyway 75 welded or otherwise secured on the underside of the base 80 of a dished receptacle 78. A stem 76 secured at one end to a handle 73 and projects, at the end remote from said handle 73, through an opening 82 in the base 80 and is secured to the underside 83 of a nested dished receptacle which accommodates a mirror 72.

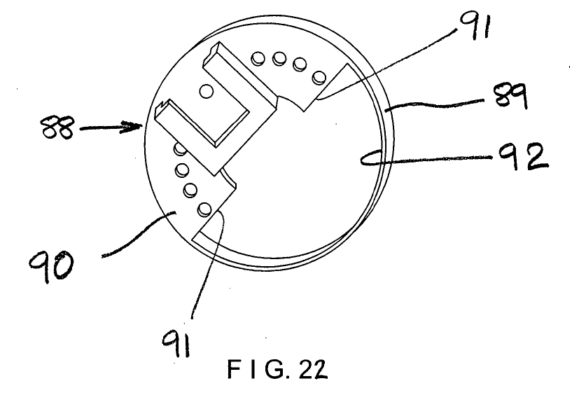

FIG. 22 is a view similar to FIG. 21 but is illustrative of an embodiment in which the retractor retaining dished receptacle 88 can be replaced. In this embodiment the opening 92 in the base 90 of the receptacle 88 is larger than the sector shown in FIG. 21 and is dimensioned to permit insertion and removal of the mirror and mirror retaining element therethrough. To this end, the opening 92 is defined by aligned edges 91 of the base 90 of the receptacle 88 and the peripheral rim 89. The edges 91 extend across a diameter of the base 90 whereby the inner receptacle (not shown) can be angularly tilted with respect to the outer receptacle 88 by a handle and interconnecting stem integral with said mirror retaining inner receptacle. In this embodiment, the rim 89 and base 90 of the receptacle 88 provide a sufficiently large bearing area positively to retain the inner receptacle within the retractor retaining receptacle and to apply sufficient force to hold displaced gum or tissue away from the area being examined or worked on.

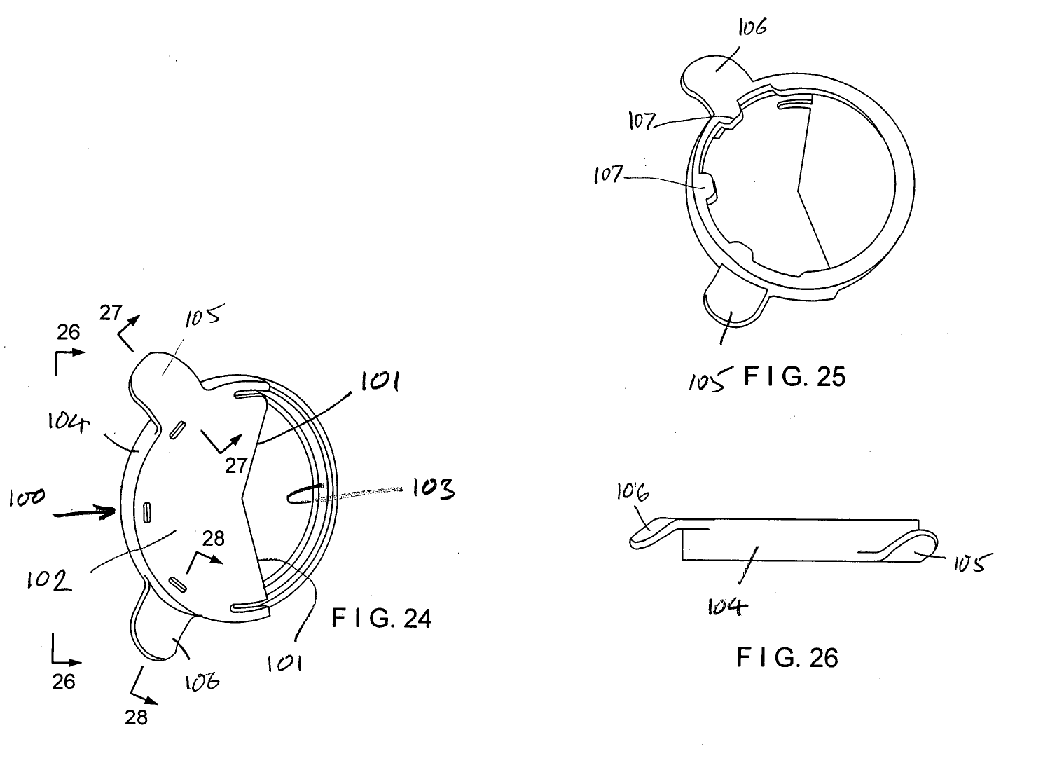

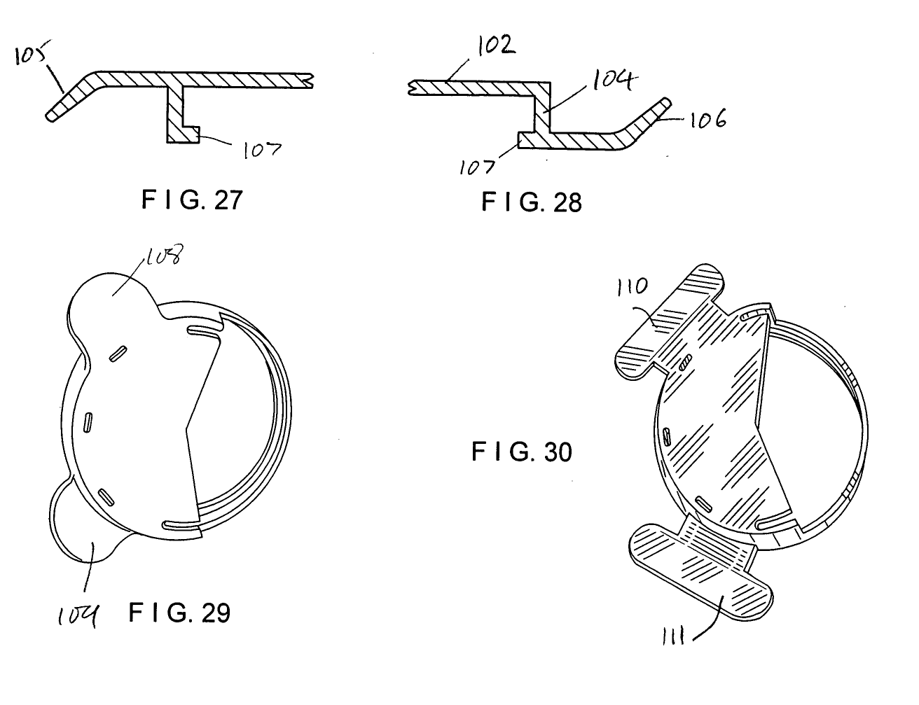

The foregoing embodiments described with reference to FIGS. 11 to 22 all permit replacement, or substitution, of retractors in order to select the correct configuration for the area of the mouth to be examined. Another way of achieving selection of retractors is to provide a disposable retractor and mount which can be discarded after use and replaced by another retractor and mount having the same or different geometric configuration. Examples of such disposable retractors and mounts are shown in FIGS. 24 to 28, 29 or FIG. 30 of the drawings.

In the embodiment shown in FIGS. 24 to 28 of the drawings, a dished receptacle 100 has an opening 103 defined by angled edges 101 on a base 102. A peripheral rim 104 upstands from the base 102 and, as in the embodiment illustrated in FIG. 22, the angle subtended by the edges 101 defines an the opening 103 which is large enough to permit insertion and removal of a mirror and mirror retaining element therethrough.

FIGS. 25, 27, and 28 most clearly show tongues or lugs projecting radially inwardly from the upper edge of the rim 104 to seat over an edge portion of a mirror introduced through the opening 103 and retain said mirror firmly seated on the base 102.

As the entire dished receptacle 100 is disposable and intended for one-time use only, it is preferably cast or moulded to a size which will snap on or otherwise fit a standard mirror without the interposition of an inner dished receptacle. However, inner and outer dished receptacles of the type previously described may be used.

In the previously-described embodiments, the retractors and, where appropriate, the supporting dished receptacles therefor are of stainless steel and can be sterilized between uses. As the dished receptacles described with reference to FIGS. 24 to 30 are disposable, it is not necessary for them to be stainless steel and they are preferably of a molded hard plastics material such as, for example, polypropylene, which can be rendered sterile for a single use then discarded.

In each of the embodiments illustrated in FIGS. 24 to 30, the dished receptacles each have two integral retractors spaced from one another and each of which projects radially from the peripheral rim 104. As most clearly shown in FIGS. 26, 27, and 28 of the drawings, the first retractor 105 extends radially from a location proximate the base of the receptacle and is angled upwardly, whereas the retractor 106 extends radially from a location proximate the upper edge of the rim 104 and is angled downwardly. In this manner, the same dished receptacle having oppositely directed retractors can be used on a mirror to inspect either the inside gum area or the outside gum area surrounding a tooth.

The embodiments shown in FIGS. 29 and 30 are similar to the embodiment shown in FIGS. 24 to 28 but illustrate different finger-like configurations of the two retractors. Thus, in FIG. 29, each retractor 108,109, instead of being finger-like as in FIG. 24, has a broader base and a more generally semicircular appearance whereas, in claim 30, each retractor 110, 111 is essentially T-shaped.

Although the invention finds particular application in the field of dentistry, and has been described in terms of a dental implement, it could also be used in any environment where inspection of a relatively inaccessible area has to be made. By way of example only, a mechanic might use a similar, but larger, tool in examining concealed areas under the hood of an automobile. In such a use, the mirror would enable the viewing of such areas while a component integral with or attached to the mirror and analogous to the retractor would serve to hold cables, for example, out of the sight line.

1. A dental implement having an elongated handle, a mirror at one end of said handle and a retractor extending beyond said mirror.

2. A dental implement as claimed in claim 1, wherein the retractor is integral with said mirror.

3. A dental implement as claimed in claim 2, wherein the mirror is substantially circular and sits in a dished receptacle secured at said one end of said elongated handle and wherein the retractor is integral with and extends substantially radially outwardly from said dished receptacle.

4. A dental implement as claimed in claim 3, wherein the mirror is substantially circular and sits in a dished receptacle secured at said one end of said elongated handle and wherein the retractor is selectively engageable with said dished receptacle and extends substantially radially outwardly therefrom.

5. A dental implement as claimed in claim 3, wherein the retractor lies in substantially the same plane as the dished receptacle.

6. A dental implement as claimed in claim 4, wherein the retractor lies in substantially the same plane as the dished receptacle.

7. A dental implement as claimed in claim 3, wherein the retractor is bent about a fold line with respect to the plane of the dished receptacle.

8. A dental implement as claimed in claim 4, wherein the retractor is bent about a fold line with respect to the plane of the dished receptacle.

9. A dental implement as claimed in claim 1, wherein the angle which the retractor makes with respect to the elongated handle is adjustable.

10. A dental implement including an elongated handle, a mirror mounted at one end of said handle, said mirror being substantially circular, a dished receptacle having a base and an upstanding peripheral rim dimensioned to seat over said mirror with said base underlying the underside of said mirror and said peripheral rim engaging the periphery of said substantially circular mirror for relative rotation between said mirror and dished receptacle and at least one retractor carried by said dished receptacle and projecting substantially radially outwardly therefrom.

11. A dental implement as claimed in claim 10, wherein the elongated handle is secured to said underside of said mirror and wherein an opening is provided in said base of said dished receptacle to provide access for said elongated handle.

12. A dental implement as claimed in claim 11, wherein the at last one retractor is releasably retained on the underside of the base of said dished receptacle.

13. A dental implement as claimed in claim 12, wherein a channel is located on the underside of said base selectively to receive one end of said retractor.

14. A dental implement as claimed in claim 13, wherein the retractor extends outwardly from said channel generally radially with respect to said dished receptacle and wherein said retractor is angled about a fold line at a location intermediate the length thereof whereby the outer end of said retractor is bent upwardly with respect to the plane of said dished receptacle.

15. A dental implement as claimed in claim 13, where in the channel is a U-shaped keyway.

16. A dental implement as claimed in claim 10, wherein the mirror is seated in a first dished receptacle and said first dished receptacle is in turn seated in a second larger dished receptacle, wherein the elongated handle is secured to the underside of said first dished receptacle and passes through an opening in the base of the second larger dished receptacle, wherein spring biased plunger means carried by said first dished receptacle is arranged selectively to enter one of a series of arcuately disposed openings in the second larger dished receptacle to restrain said first and second dished receptacles from rotation relative to each other, and, wherein said at least one retractor is carried by said second dished receptacle.

17. A dental implement as claimed in claim 12, wherein the dished receptacle and said at least one releasably retained retractor are made of stainless steel.

18. A dental implement including an elongated handle, a substantially circular mirror carried at one end of said handle, a replaceable dished receptacle having a base and an upstanding peripheral rim dimensioned to seat over said mirror with said elongated handle passing through an opening in said base of said dished receptacle, said dished receptacle having at least one retractor integral with and extending substantially radially therefrom, said dished receptacle and said at least one retractor being made of a hard plastics material.

19. A dental implement as claimed in claim 18, wherein two retractors, spaced one from the other, each extend substantially radially from the dished receptacle.

20. A dental implement as claimed in claim 19, wherein the retractors are bent, one upwardly and the other downwardly, about the fold lines at locations intermediate their lengths.

21. A dental implement as claimed in claim 18, wherein the or each retractor is finger shaped.

22. A dental implement as claimed in claim 18, wherein the or each retractor is T-shaped.

23. A viewing instrument comprising an elongated handle, a mirror at one end of said handle and a finger or like element projecting beyond and fixed or removably attached to said mirror.

24. For use with a dental implement including an elongated handle and a substantially circular mirror carried at one end thereof, retractor means including a replaceable dished receptacle having a base and an upstanding peripheral rim dimensioned to seat over said mirror with said elongated handle passing through an opening in said base of said dished receptacle, said dished receptacle having at least one retractor integral with and extending substantially radially therefrom, said dished receptacle and said at least one retractor being made of a hard plastics material.

25. Retractor means as claimed in claim 24, wherein two retractors, spaced one from the other, each extend substantially radially from the dished receptacle.

26. Retractor means as claimed in claim 25, wherein the retractors are bent, one upwardly and the other downwardly, about the fold lines at locations intermediate their lengths.
